(19) United States
(12) Patent Application Publication
(10) Pub. No.: US 2005/0102283 A1
(43) Pub. Date: May 12, 2005

(54) System with an interactive, graphical interface for delivery of planning information and consulting materials, research, and compliance information relating to tax or other forms

(76) Inventors: Stephen J. Anderson, Clifton, VA (US); Kelly Murray, Arlington, VA (US); Christina Vogel, Fairfax, VA (US); David Gilbertson, Burke, VA (US); Bruce Larsen, Springfield, VA (US); Gary On, Arlington, VA (US); Christopher Wooley, Gaithersburg, MD (US); Patricia Hines, Arlington, VA (US); Shawn McCaig, Wyandotte, MI (US)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 10/686,425

(22) Filed: Oct. 15, 2003

(51) Int. Cl. G06F 17/30

(52) U.S. Cl. 707/4

(57) ABSTRACT

An interactive, graphical depiction of a form (e.g., a tax, banking, insurance or other form) is presented through a computer network. A request is received through the network for information relating to a location on the form selected by a user, where the selection is made through interaction with the graphical depiction of the form. Information is delivered to the user through the network in response to the request. The delivered information may include one or more of the following relating to the selected form location: planning information, consulting materials, research and compliance information. An interactive depiction of a map or series of maps also may be presented through the network. The user may interact with the map to obtain jurisdiction-specific information on a topic that relates to the subject matter of the graphical, interactive form. The jurisdiction-specific information also may be delivered to the user through the network.

### BACKGROUND

This disclosure relates to the delivery of planning information and consulting materials, research, and compliance information through the use of an interactive, graphical interface.

Many situations require individuals, corporations or other entities to complete and submit various standardized forms. For example, the United States federal government, as well as state and foreign governments, typically requires individuals, corporations and other entities to complete and file tax forms on an annual or other periodic basis.

Many users find that such forms are complex and contain insufficient information and guidance regarding how certain items on the form should be answered. Questions may arise, for example, about the law applicable to a particular line on the form or the meaning of terminology used in connection with a particular item on the form.

Although many research resources may be available to assist individuals in completing the forms, locating and identifying those resources that pertain to an individual line on the form can be a time-consuming task. Furthermore, different sources may use different terminologies for the same concept, thus making the use of keyword indices and keyword searching cumbersome and unreliable.

In addition to accomplishing the primary purpose, such as a tax form allowing for the self-assessment of tax liability, the forms also generally provide a standard measure of a current situation. As such the form, once completed can be used as an evaluation tool. In the case of a tax form, the form can be used to plan future business activities so as to reduce future tax liabilities.

### BRIEF DESCRIPTION OF THE DRAWINGS

FIG. 1 illustrates an example of a network-based system according to the invention.

FIG. 2 illustrates an example of the type of information that may be stored as a tax planning idea.

FIG. 3 illustrates an entry screen for the classification of the idea according to the form line.

FIG. 4 illustrates an entry screen for marking the appropriate foreign jurisdictions.

FIG. 5 illustrates an entry screen for marking the appropriate state tax information.

FIG. 6 illustrates a screen for searching tax planning information and consulting materials.

FIG. 7 illustrates a screen that includes a graphical, interactive tax form according to the invention.

FIG. 8 illustrates part of a screen that includes a list of tax planning ideas associated with a particular line on a tax form.

FIG. 9 illustrates a further part of the screen of FIG. 8 including links to tax information from third-party sources.

FIG. 10 illustrates a screen that includes an interactive map for obtaining tax planning ideas relating to state taxes.

FIG. 11 illustrates a screen that allows for the selection of categories of tax planning ideas for a particular state.

FIG. 12 illustrates a screen which allows for the selection of tax ideas by relation to a state form or general tax category.

FIG. 13 illustrates a screen that includes a list of tax planning ideas and links to third-party sources of information about a particular state's taxes.

FIG. 14 illustrates a screen showing an interactive depiction of the New York State Corporate Franchise Tax Form, Form CT-3.

FIG. 15 illustrates an example of a screen showing tax planning ideas, consulting information and third party research related to “Line 4a” of a New York State Corporate Franchise Tax Form, Form CT-3.

FIG. 16 illustrates a screen that allows for the selection of information about groups of states that impose a specified type of tax.

FIG. 17 illustrates a screen that includes an interactive map for obtaining tax planning ideas for other jurisdictions (e.g., Europe).

FIG. 18 illustrates part of a screen that includes a list of tax planning ideas associated with a particular country selected from the interactive map of FIG. 17.

FIG. 19 illustrates a further part of the screen of FIG. 11 including links to tax information from third-party sources.

### SUMMARY

This disclosure relates to the display of a form for the selection and delivery of information relating to the subject of the form through the use of an interactive, graphical interface.

As used herein, a “form” refers to a document with one or more areas for the insertion of required or requested information.

In many implementations, the form will be a standardized form, and may include blank space where the required or requested information is to be entered.

In various implementations, planning information, consulting materials, research, or compliance information relating to the form may be delivered to a user.

The system, described in greater detail below, can help a user locate and identify resources that pertain, for example, to an individual line or other location on the form. Additionally, the forms may be used as a means of identifying relevant planning opportunities and as a basis for organizing more favorable business transactions.

In one aspect, a system implements a method that includes presenting an interactive, graphical depiction of a form through a computer network and allowing for selection of a desired location on the form. A request is received for information relating to a location on the form selected by a user, where the selection is made through interaction with the graphical depiction of the form. Information is delivered to the user through the network in response to the request. The delivered information includes at least one of the following relating to the selected form location: planning information, consulting materials, research and compliance information.

The information delivered to the user may be specific to the particular location on the form selected by the user. Furthermore, information on topics relating to different parts of the form may be delivered to the user through the network in response to the user's selecting other locations on the graphical, interactive form.

The techniques may be particularly advantageous, for example, in connection with the delivery of information relating to the consulting needs of a client, broad research, and specific information needed in the completion of tax forms, securities forms, insurance forms and banking forms. The techniques may be used with other types of forms as well.

In some implementations, the method also may include presenting an interactive depiction of a map or series of maps through the network. The user may interact with a section of the map that corresponds to a particular geographic location to obtain jurisdiction-specific consulting, research and compliance information on a particular topic. The jurisdiction-specific information also is delivered to the user through the network.

Ideas, including the planning information and consulting materials, that are linked to the selected line location on the form may be retrieved from a database and delivered to the user through the network. In some implementations, the user also may receive a list of hyperlinks for research and form compliance information from third-parties that relates to the selected form line location. Some of the hyperlinks may provide access to information from subscription-based services. The user may be authenticated to a third-party site associated with a selected hyperlink in a manner that is transparent to the user.

In some implementations, one or more of the following advantages may be present. For example, the techniques may facilitate obtaining access to and delivering planning information, consulting materials, research, and compliance information related to a particular line or other location on a form. As a result, identifying applicable planning information and consulting materials, and finding relevant research information for various types of forms (and individual lines within the forms) may be simplified and made easier for users.

In the context of tax forms, the synergistic effect, for example, of having tax planning information and consulting materials closely tied to the research may allow the user to determine the fit of the idea with the instant situation more easily and quickly.

Other features and advantages will be readily apparent from the following detailed description, the accompanying drawings and the claims.

### DETAILED DESCRIPTION

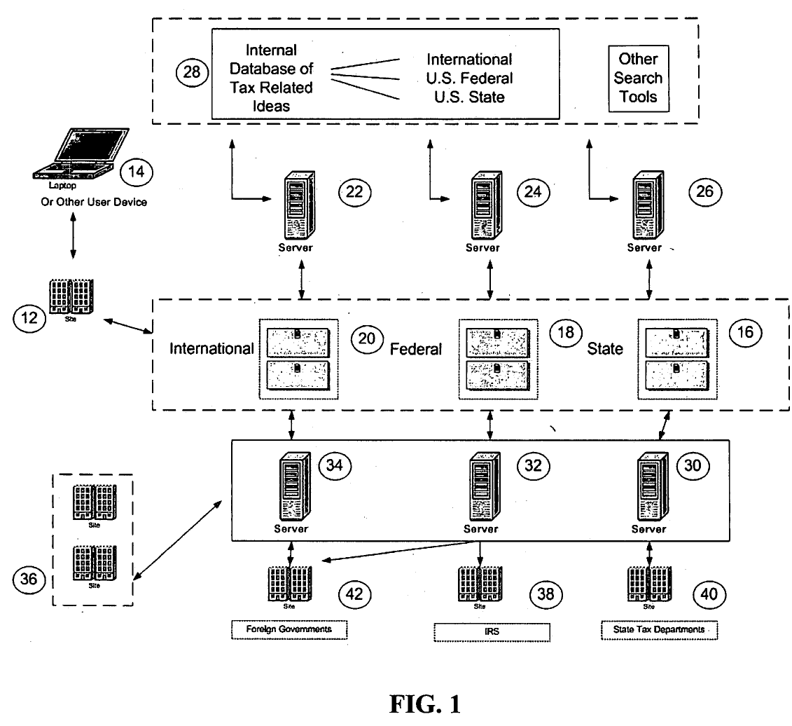

As shown in FIG. 1, an on-line, interactive computer system allows a user to access an Internet or other network site 12 through a user device such as a personal computer 14 with a browser and a display screen. The device also includes means (e.g., an electronic mouse or keyboard) to allow the user to make selections and interact with the display screen. Access to the network site 12 also may be provided through other user devices, such as a personal digital assistant (PDA).

The site provides the user with a graphical, interactive interface that allows the user to access planning information and consulting materials, research and compliance information related to a particular selected location (e.g., a line item) on a form or related to a selected jurisdiction. For example, in one implementation, the site may provide the user with information about federal, state and foreign taxes by tax form or taxing jurisdiction. The graphical interface, described in greater detail below, provides the user with established links to one or more databases or network sites with information relating to a selected form or a selected jurisdiction. The databases are pre-populated with the relevant information such as planning information, consulting materials and links to third-party sites. Links to third-party sites may be for subscription-based services as well as for publicly available, non-subscription information.

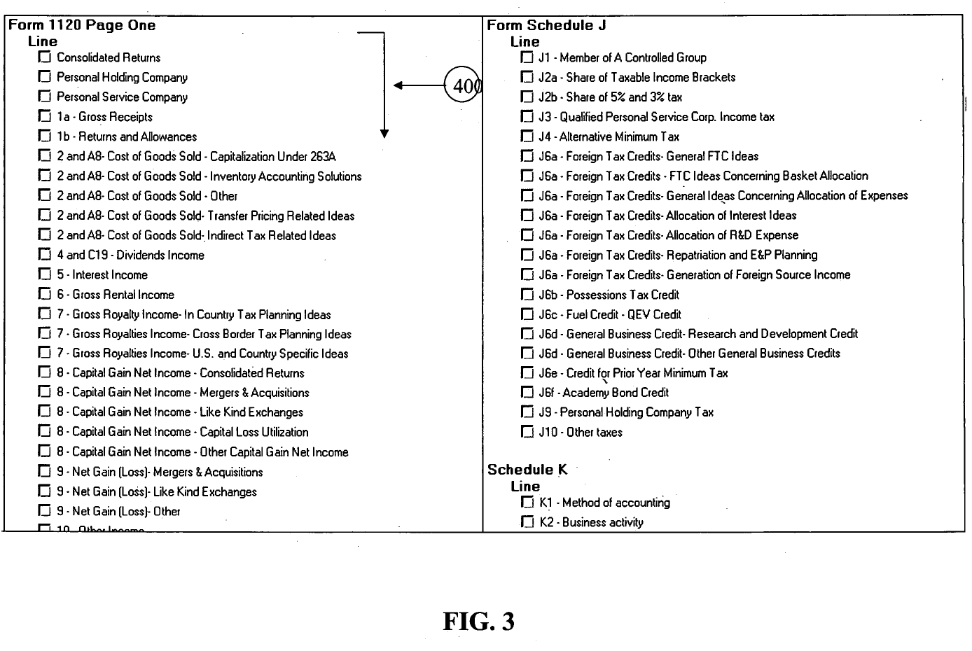

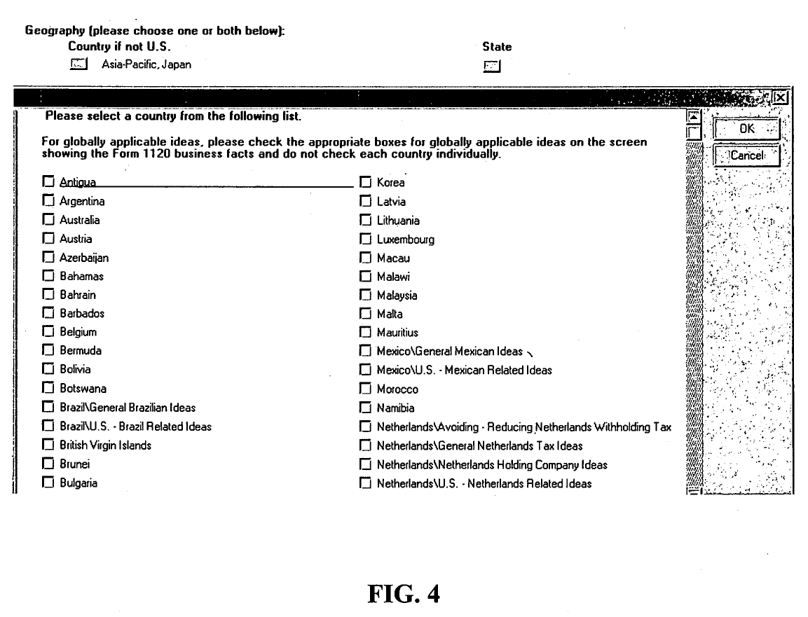

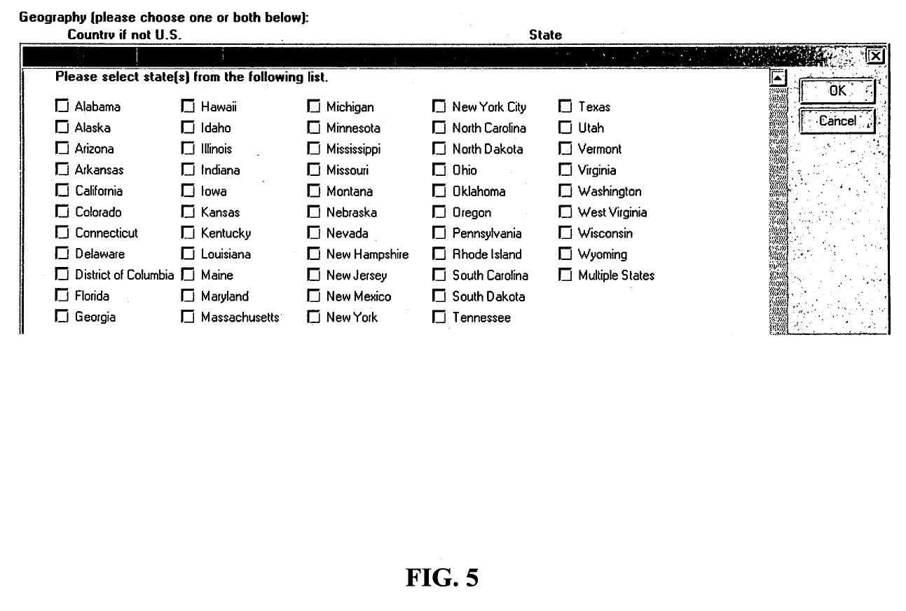

In the context, for example, of a system that provides information relating to taxes, the system may provide electronic pages 16, 18, 20 of information relating, respectively, to state, federal or international taxes, depending on the information desired by the user. One or more servers 22, 24, 26, may establish links to an internal database 28 of tax planning information and consulting materials. The database 28 stores ideas, each of which may be linked, for example, to one or more sections of a tax form or to a geographical location, such as a country or state. The linking may be done by marking each planning idea with a relevant link through use of the screens in FIGS. 3, 4, and 5.

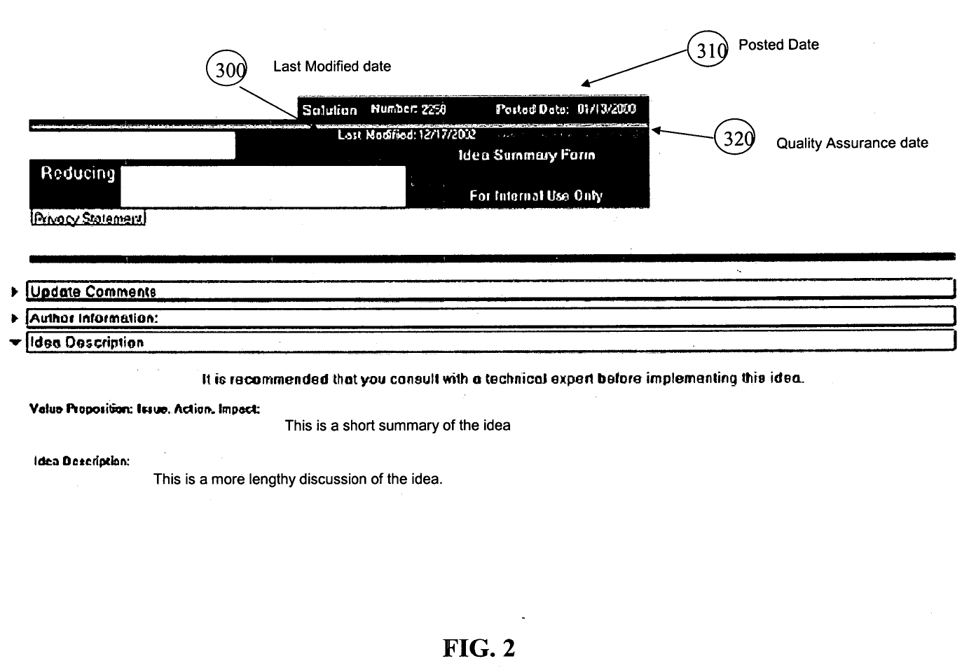

FIG. 2 illustrates an example of the type of information that may be stored as a planning idea in the database 28 and that may be linked, for example, to a particular line on a tax form. The idea may include planning information and consulting materials. The particular idea illustrated in FIG. 2 is entitled “Reducing . . . ” The database may store information about when the idea was first posted 310, when it was last modified 300, when the idea was last reviewed by the author (quality assured date) 320 as well as information about the author of the idea. The database also would include a description of the idea and may include other details that explain background information about the idea. The planning idea may also be presented to the user in response to clicking on a link in the graphical interface, as described in greater detail below. Further information classifying the relationships of the idea that are stored with the idea are shown in FIGS. 3, 4, and 5.

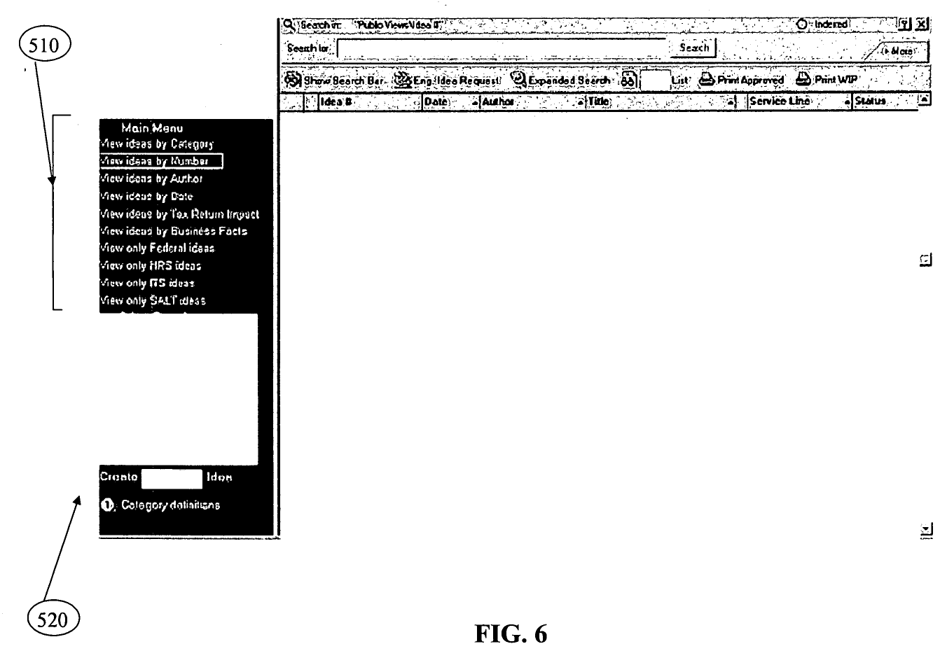

Administration of the database 28 includes the ability to search and list tax planning ideas stored in the database as well as the ability to create new tax ideas to be stored in the database. As illustrated in FIG. 6, the planning ideas stored in the database 28 may be searched and listed in any number of ways, such as by category, number, author, date, impact on a form, etc., by selecting the appropriate link 510. Ideas may be created and stored using the link 520.

As shown in FIG. 1, the servers 22, 24, 26 also may provide access to other search tools to enhance the capabilities of the system.

Additional servers 30, 32, 34 may establish direct links to Internet sites of third-party content providers. Such content providers may include, for example, Westlaw, The Bureau of National Affairs, Inc. (BNA) or other content providers that offer subscription-based services 36. The links may include sources of law, such as the relevant statutes, regulations and legal decisions, as well as explanations and discussions that pertain to the particular selected section of the form. The servers also may establish direct links to government or other non-subscription sites such as the Internal Revenue Service (IRS) 38, state tax departments 40 and foreign governments 42 to obtain other related information.

The servers 30, 32, 34 may establish hard links to web pages that are created based on the search of the information shown in FIGS. 3, 4 and 5 and that show the information associated, for example, with a particular line on a tax form or with tax information relevant to a particular geographical location. Alternatively, in some cases, dynamic links may be established so that the information may be updated automatically within the site 12 on an ongoing basis.

Some third-party web sites may require user identification codes or passwords to access their services, particularly those sites that provide subscription-based services. To facilitate use of the present system, assigned system user-identification codes and passwords may be used so that, from the user's perspective, the authentication process required to access information obtained from the third-party content providers is transparent. In particular, the site 12 serves as a hub to provide users with access to links that obtain electronic documents and files from third-party vendors' web sites. A user authentication script allows the user to click on a link, for example, using an electronic mouse or other input device, and to access an electronic document or file from a secure vendor site without having to log onto the site with his own password. When the user clicks on a link to a vendor's web site from the web site 12, an authentication script informs the vendor site that the user accessing the web site should be granted access.

Communications between the host servers 30, 32, 34 through the user authentication script and the vendor's servers may take place in any one of several ways. In one implementation, the user authentication script may access a database that has a list of all individuals who have access to the vendor, and match the user's identification with the database. If a match is found, the user is given access. Alternatively, the user authentication script may include a firm-wide username and password within the script itself so that the user is logged in automatically when the user clicks on the link. In other implementations, the user authentication script may set an electronic cookie on the user's device with an expiration period.

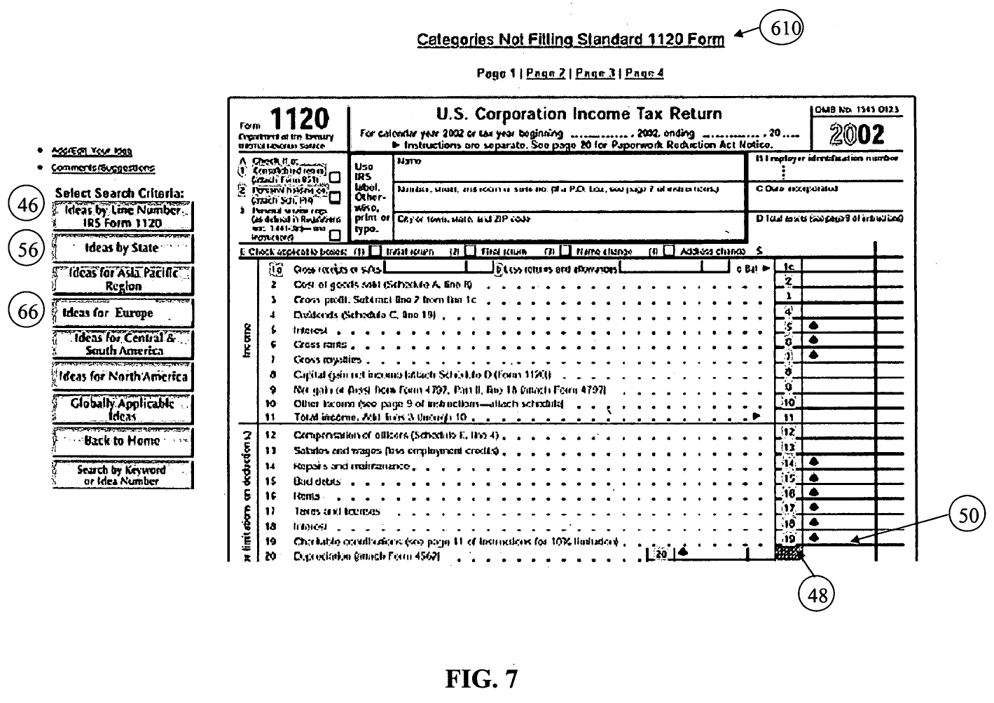

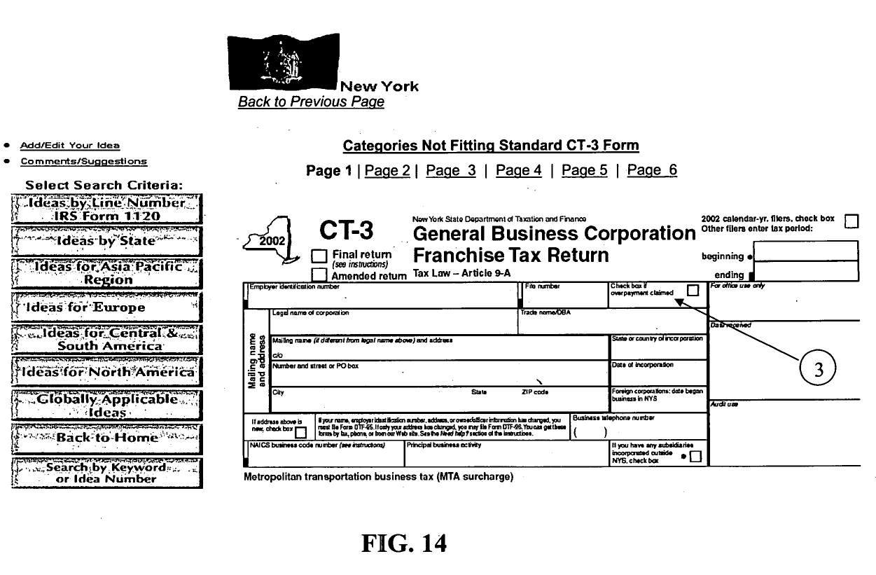

In one implementation, the site 12 may revolve around corporate tax forms. FIG. 7 illustrates an example of a web page associated with the site 12 according to a particular implementation. In this case, the opening page provides a graphical interactive depiction of the Internal Revenue Service (IRS) Form 1120, entitled “U.S. Corporation Income Tax Return.” In other tax implementations, the graphical interface may depict other tax forms, such as a state corporate income tax return (see, e.g., FIG. 14), an estate and gift tax form or an individual income tax form. Similarly, other subject areas would display the relevant forms.

Different areas of the form may be highlighted or otherwise indicate that a hyperlink is associated with that part of the form. For example, in the illustrated example, various line numbers 48 on the tax form are highlighted. When the user clicks on one of the highlighted areas (e.g., a line number), a list of tax-related planning information and consulting materials associated with the particular area of the form is retrieved from the database 28. The list of ideas is provided to the user's device 14 through the web site 12. A separate indicator 50 also may appear on some of the tax lines to indicate that research materials associated with third-party web sites 36, 38, 40, 42 are available for those lines. For example, line 19 of the tax form includes such an indicator 50. Other types of indicators may also be used to denote additional materials, such as compliance information, where applicable.

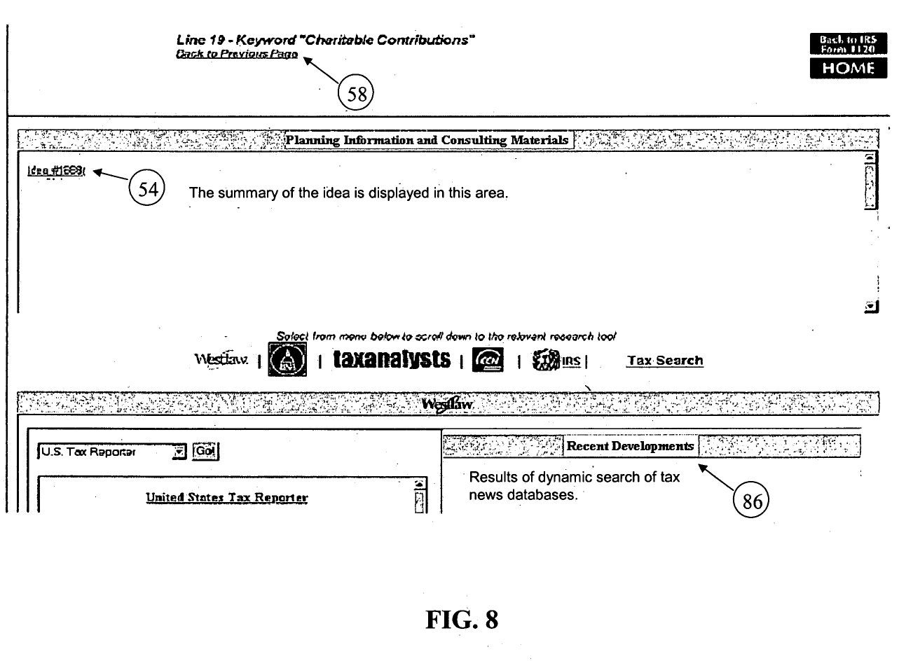

To illustrate how the graphical, interactive system can work, it is assumed that a user clicks on the link associated with line 19 of the tax form in FIG. 7. A partial list of tax planning ideas that are associated with line 19 of the tax form is displayed to the user on a display screen coupled to the user's device (see FIG. 8). In this example, one idea obtained from the database 28 is listed. Typically, further details about the idea would appear on the screen. To view the complete description of a particular idea, the user may be required to click on the highlighted number or title of the idea that would link with the complete idea description.

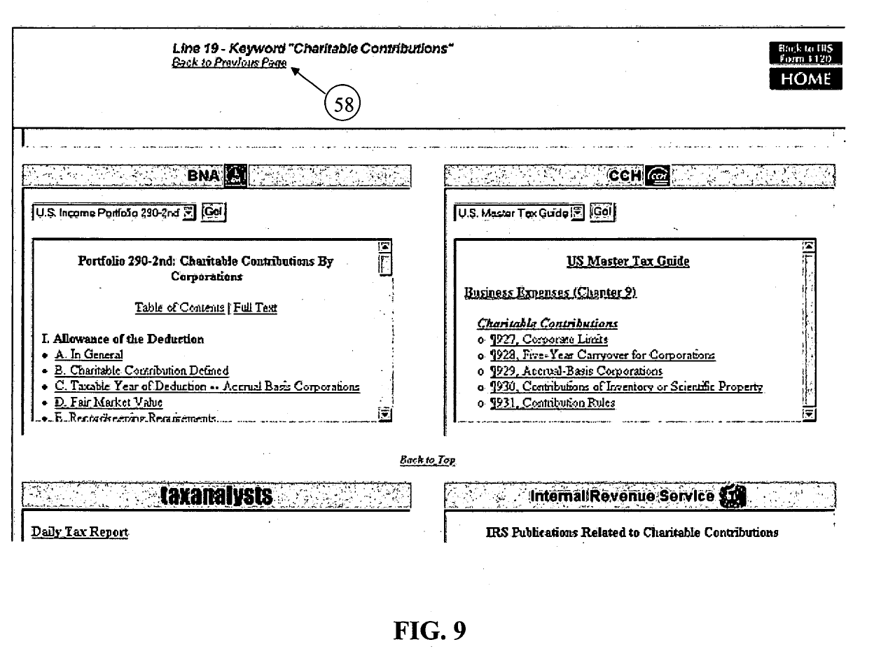

By continuing to scroll down the screen, (see FIG. 9) the user can choose to view information from one of the external, third-party sources of information, such as one of the subscription services web sites 36. The information retrieved by the server(s) from those web sites would relate to the selected line on the form, in this case, line 19 of the U.S. Corporate Income Tax Form.

As the user continues to scroll down the screen, other primary and secondary source materials may be listed. Each of the listed items relates to the selected line on the form. The user can view the complete text or file of a listed item by clicking on the link. To return to a view of a previous page, the user may click on the link entitled “Back to Previous page” 58. Similar types of information may be obtained for other lines on the tax form in FIG. 7 by clicking on the appropriate link(s) in the graphical view of the form.

As shown in FIG. 7, the interactive interface also may include a link 610 to categories of tax ideas that do not fit the standard Form 1120.

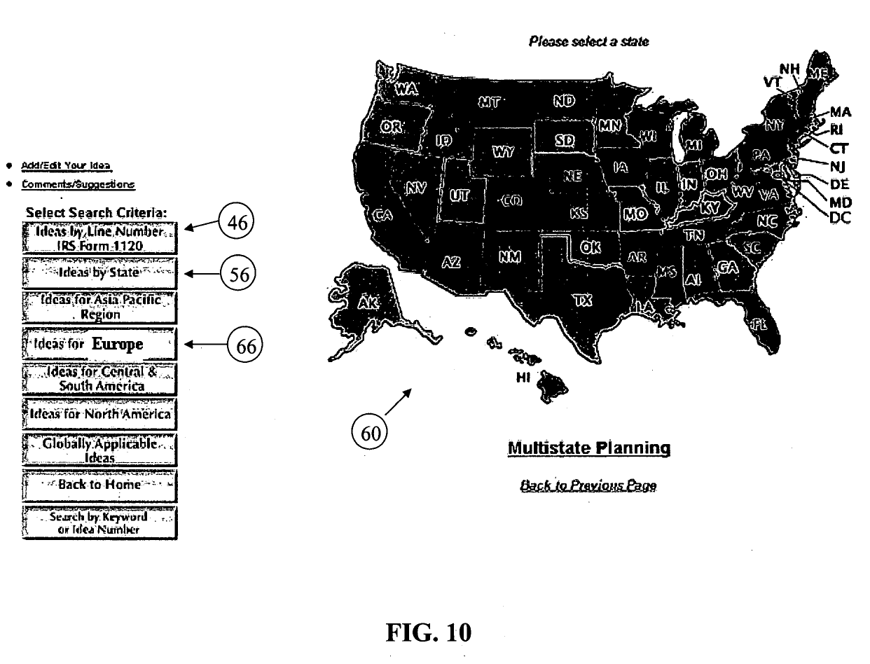

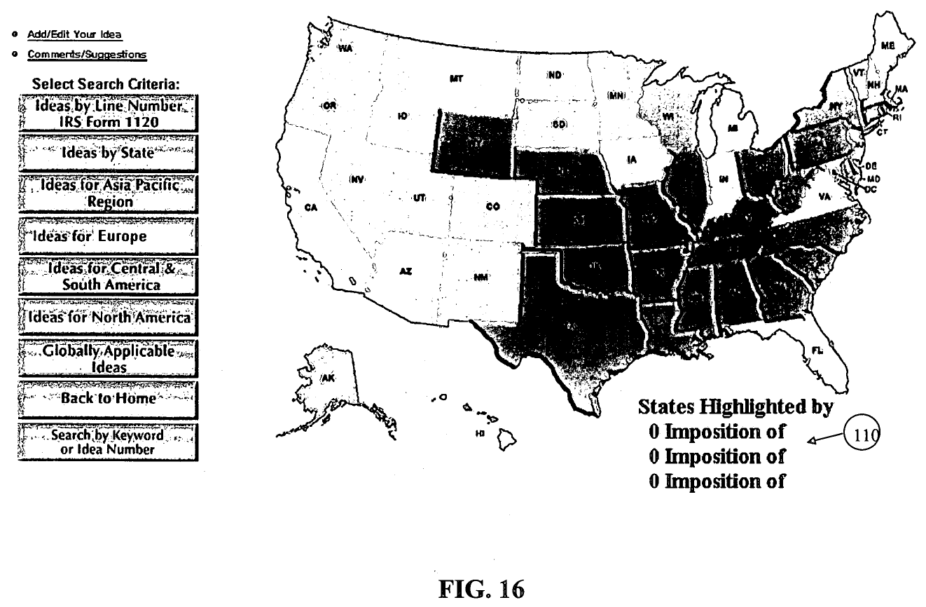

Use of a graphical, interactive form that allows a user to obtain planning information and consulting materials, research, and compliance information related to the subject matter of the form may be combined with the delivery of jurisdictional information through an interactive map or series of maps. Each map may depict a region, such as a country or continent. For example, in one implementation, the user may obtain tax information about a particular state in the United States by clicking on the box 56 entitled “Ideas by State” (FIG. 7). In response, the system displays an interactive map 60 (FIG. 10) of the United States from which the user may select a particular state of interest. The site 12 may allow the user to change the appearance of the map to highlight a particular subject area that is of interest to the user. For example, if a user is interested in a particular type of tax (e.g., state franchise taxes), the user may be able change the appearance of the map 60 to highlight states that impose a franchise tax by clicking an appropriate request 110 (see FIG. 16).

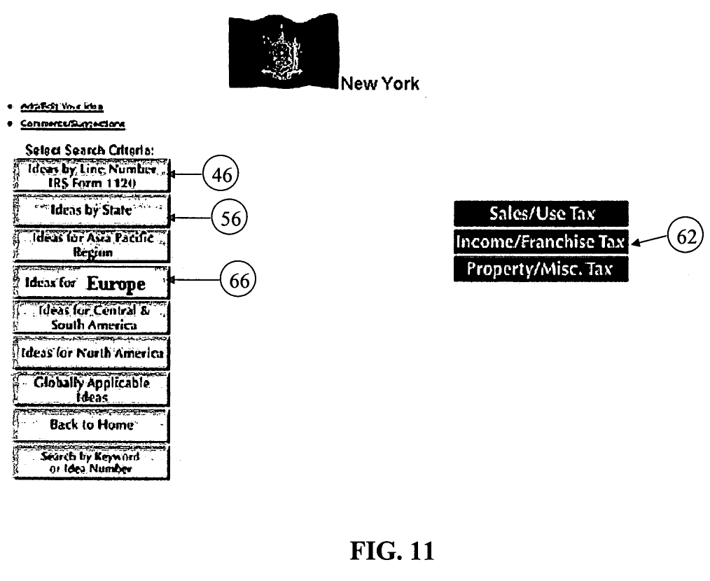

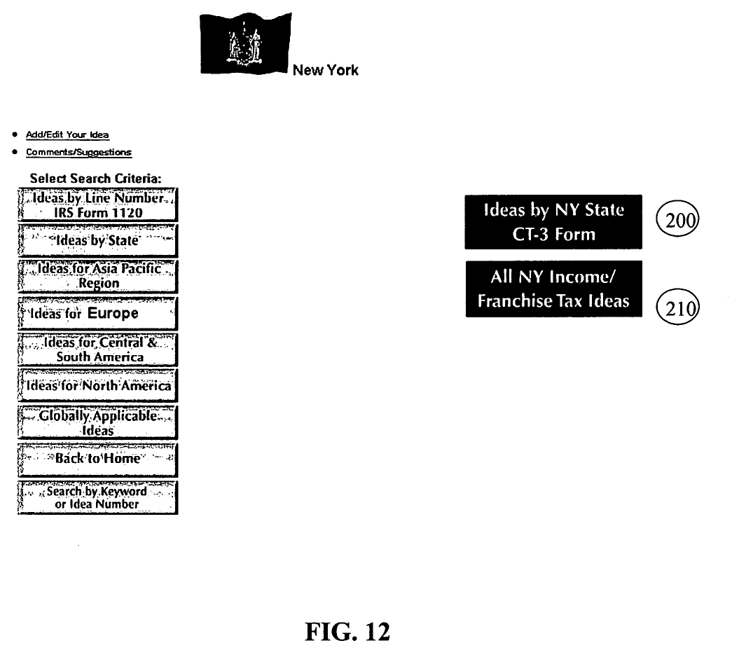

In response to a user's clicking a particular state, the system displays a screen that classifies the types of tax ideas for that state. For example, if the user were to select New York from the interactive map 60 (FIG. 10), the system would display a screen as shown, for example, in FIG. 11. The user then may select one of the categories of taxes for the State of New York. In the illustrated implementation, the user may select from the following categories: sales and use taxes, income and franchise taxes, and property and miscellaneous taxes. If the user were to select, for example, the link 62 for income and franchise tax ideas, the system would display a screen such as the one illustrated in FIG. 12.

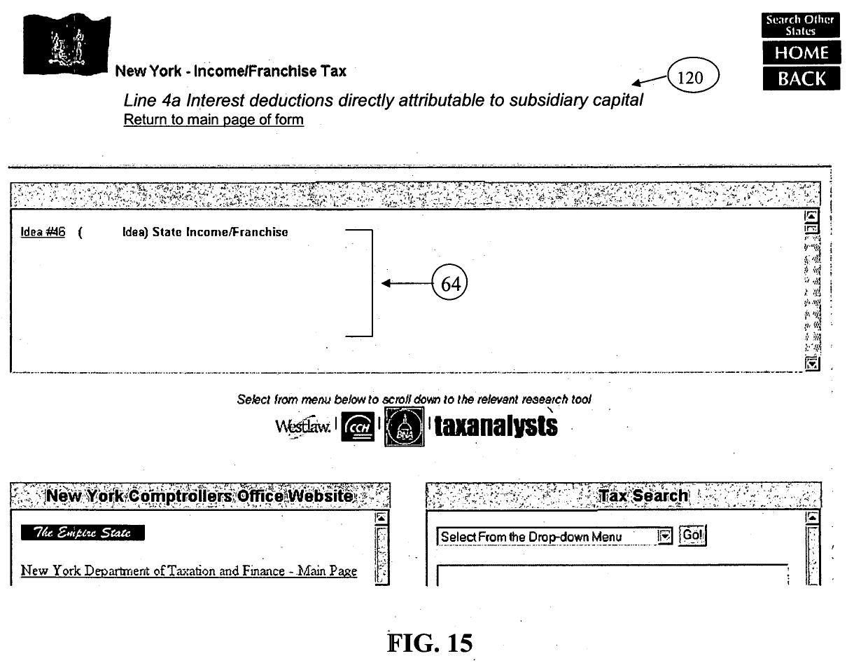

In the illustrated implementation (FIG. 12), the user may select a link entitled “Ideas by New York State CT-3 Form” 200 or a link entitled “All NY Income/Franchise Tax Ideas” 210. If user were to select the link 200 the system could display a screen such as the one illustrated in FIG. 14. That screen shows New York State's standard corporate tax return form CT-3. As described in connection with the federal tax form, the user can click on a link associated with a particular line on the Form CT-3, and the system would display a screen such as the one illustrated in FIG. 15 with the identification 120 shown on the top of the screen.

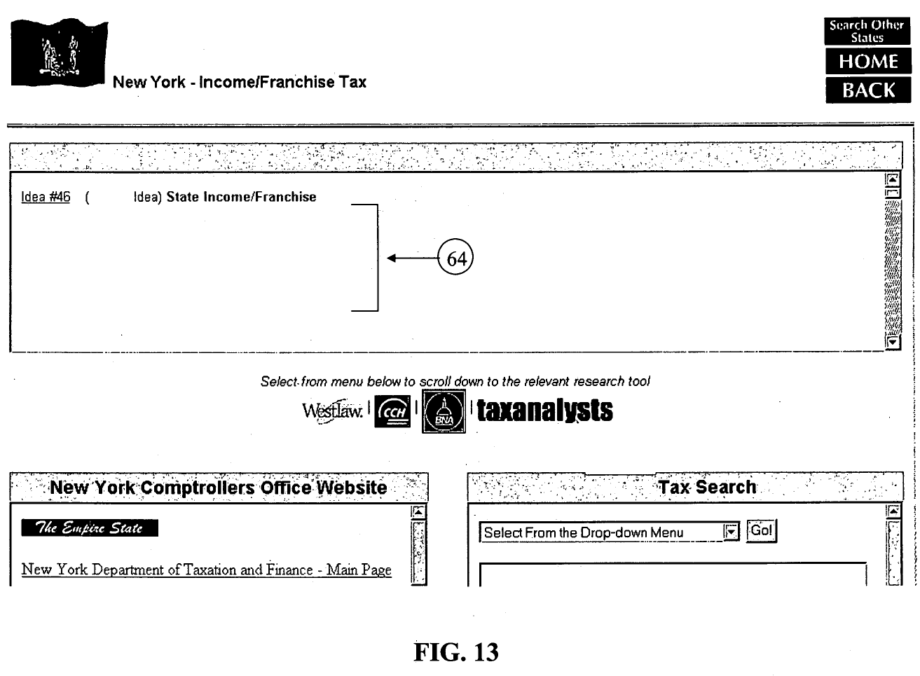

Alternatively, if the user were to select the link 210 entitled “All NY Income/Franchise Tax Ideas,” the system would display a screen similar to the one illustrated in FIG. 13. The screens in FIGS. 13 and 15 display one or more tax ideas 64 obtained from the database 28 and that relate to the selected tax category for the selected state. As described in connection with the ideas for the federal tax form, the user can view the complete description of an idea associated with a particular state's taxes by clicking on the link for that idea.

By scrolling down through the screen, the user may choose to view information obtained from other sources about the state's taxes. The third-party sources may include, for example, the web site for the New York Comptrollers Office Website as well as web sites associated with various subscription services. In each case, the materials that are retrieved from the database 28 or accessed from the third-party sites relate to the selected tax category for the selected state.

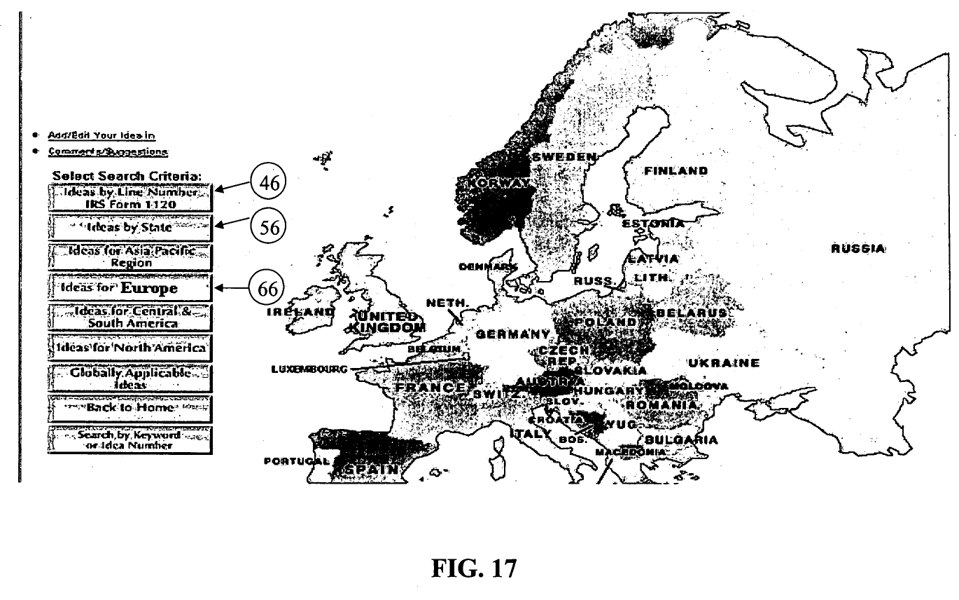

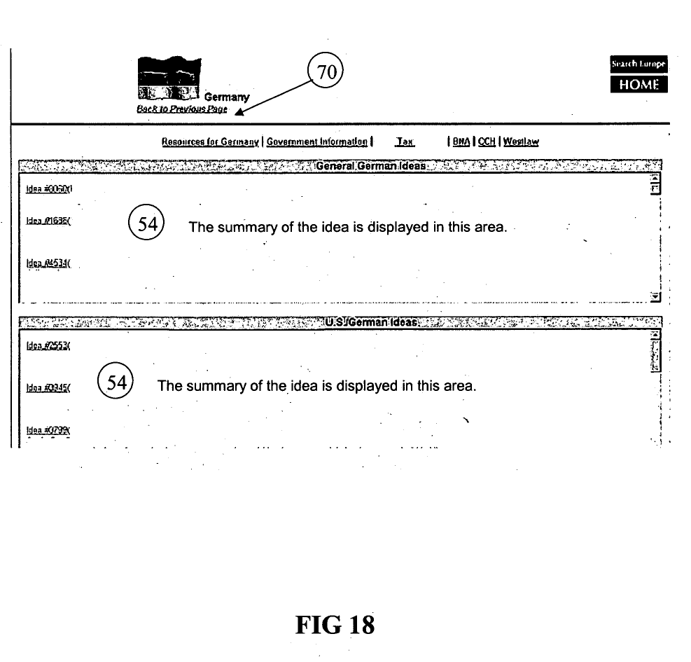

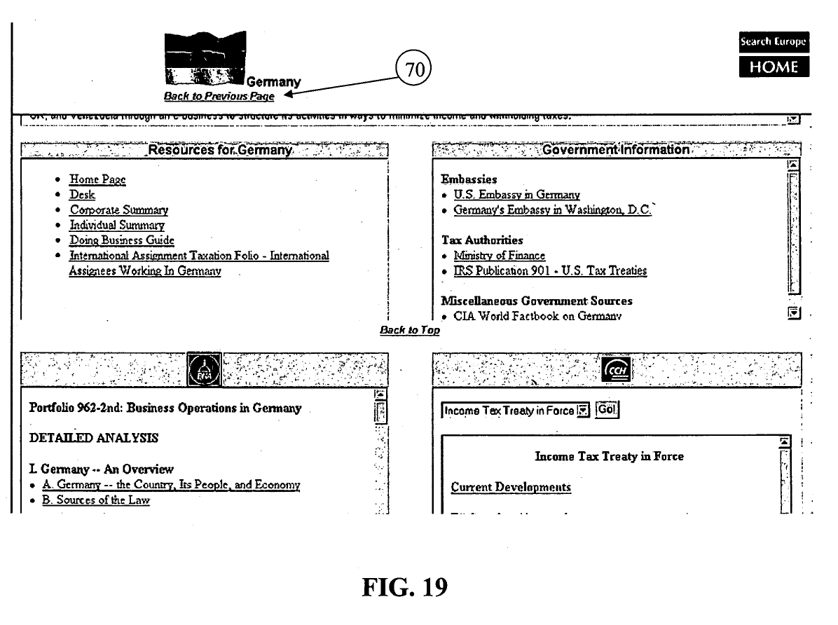

Interactive maps for other regions of the world, such as Asia, Central and South America, North America and Europe, may be selected as well. For example, to access the interactive map for Europe, the user may click on the box 66 (see FIGS. 7 and 10). The system would then display a view of an interactive map of Europe (FIG. 17) from which the user may select a particular country of interest. In response to a user's clicking on a particular country (e.g., Germany), the system displays a screen such as the one illustrated in FIG. 18 on the user's device 14. The screen includes one or more tax planning ideas 54 obtained from the database 28 and may be listed under one or more sub-groups of ideas. As described in connection with the ideas for the federal tax form and the state tax ideas, the user can view the complete description of an idea associated with a particular country's taxes by clicking on the corresponding link for that idea. By scrolling down through the screen, the user may choose to view information obtained from third-party sources about the country's taxes (see FIG. 19). In each case, the tax planning information and consulting material retrieved from the database 28 or accessed from the third-party sites relates to the selected country.

To return to the interactive map for Europe shown in FIG. 17, the user may click the “Back to Previous Page” link 70 (FIG. 18). To return, for example, to the graphical, interactive federal corporate tax form, the user may click the box 46 (see FIG. 17).

In some implementations, interactive, graphical depictions of state or foreign tax forms may be provided by the system in addition to, or instead of, federal tax forms. Similarly, interactive maps of jurisdictions other than those specifically discussed above may be used to facilitate tax research and planning.

A particular location on a form may correspond, for example, to a particular line, a particular paragraph or some other section of the form. Various sections of some forms may be assigned line numbers, paragraph numbers or other alphanumeric section designators identifying particular sections of the form. Particular locations of the form for which a user may request information may correspond to such sections.

Although the foregoing discussion is based on the use of graphical, interactive tax forms and interactive maps to deliver tax-related information, similar techniques may be used to deliver information on other subjects as well. For example, some implementations may provide graphical, interactive forms and interactive maps for use in connection with the securities, banking or insurance industries.

Various aspects of the system may be implemented in hardware, software or a combination of hardware and software. Circuitry, including dedicated or general purpose machines, such as computer systems and processors, may be adapted to execute machine-readable instructions to implement the techniques described above. Computer-executable instructions for implementing the techniques can be stored, for example, as encoded information on a computer-readable medium such as a magnetic floppy disk, magnetic tape, or compact disc read only memory (CD-ROM).

Other implementations are within the scope of the claims.

1. A method comprising:
presenting an interactive, graphical depiction of a form through a computer network and allowing for selection of a desired location on the form;
receiving a request for information relating to a location on the form selected by a user, the selection being made through interaction with the graphical depiction of the form; and
delivering information to the user through the network in response to the request, wherein the delivered information includes at least one of the following relating to the selected form location: planning information, consulting materials, research, and compliance information.

2. The method of claim 1 including:
receiving a request for information relating to a second selected location on the form selected by the user through another interaction by the user with the graphical depiction of the form; and
delivering additional information to the user through the network, wherein the additional information includes at least one of the following relating to the selected form location: planning information, consulting materials, research or compliance information.

3. The method of claim 1 wherein the form comprises a tax form.

4. The method of claim 1 wherein the selected form location corresponds to a section of the form identified by an alphanumeric designation.

5. The method of claim 1 including:
retrieving, from a database, ideas that are linked to the selected form location; and
delivering the ideas to the user through the network.

6. The method of claim 5 including providing to the user a list of hyperlinks for information from third-parties that relates to the selected form location.

7. The method of claim 6 wherein at least one of the hyperlinks provides access to pages that are pre-populated with information relating to the selected form location.

8. The method of claim 6 wherein at least one of the hyperlinks provides access to information from subscription-based services.

9. The method of claim 6 wherein at least one of the hyperlinks provides access to pages created based on a search of information contained in the individual ideas.

10. The method of claim 6 including:
receiving an indication of the user's selection of a hyperlink in the list;
authenticating the user to a third-party site associated with the selected hyperlink in a manner that is transparent to the user; and
providing to the user information relating to the selected form location, wherein the provided information is obtained from the third-party site.

11. The method of claim 1 further including:
presenting an interactive depiction of a map through the network and allowing for selection of a desired jurisdiction;
receiving a request for information relating to a selected geographic location on the map in response to the user's interaction with the depiction of the map; and
delivering additional information to the user through the network, wherein the additional information relates to the selected geographic location.

12. The method of claim 11 wherein the form comprises a tax form, and wherein the information relating to the selected form location and the additional information relating to the selected geographic location comprise tax-related information.

13. The method of claim 11 wherein the form relates to a specified subject, and wherein the information relating to the selected form location and the additional information relating to the selected geographic location comprise information about the specified subject.

14. The method of claim 11 wherein presenting the interactive map occurs in response to receiving a user selection from among a plurality of available interactive maps.

15. The method of claim 11 wherein the form relates to a specified subject and wherein the interactive map comprises a plurality of geographic regions about which information relating to the specified subject may be obtained,
the method including delivering to a user, through the network, information relating to the specified subject and associated with a particular geographic region selected by the user.

16. The method of claim 11 wherein the form relates to a specified subject and wherein the interactive map depicts a plurality of countries about which information relating to the specified subject may be obtained,
the method including delivering to a user through the network information relating to the specified subject and associated with a particular country selected by the user.

17. An apparatus comprising:
a computer network;
a user device coupled to the network, the user device including a display;
one or more servers coupled to the network to:
present on the display, via the computer network, an interactive, graphical depiction of a form; and
deliver information to the user device through the network,
wherein the information is delivered in response to receiving a request for information relating to a location on the form selected by a user, the selection being made through interaction with the graphical depiction of the form, and
wherein the delivered information includes at least one of the following relating to the selected form location: planning information, consulting materials, research and compliance information.

18. The apparatus of claim 17 including a database, wherein the one or more servers are configured to retrieve from the database ideas that are linked to the selected form location, and to deliver the ideas to the user device through the network.

19. The apparatus of claim 17 wherein the form comprises a tax form.

20. The apparatus of claim 17 wherein the selected form location corresponds to a section of the form identified by an alphanumeric designation.

21. The apparatus of claim 17 wherein the one or more servers are configured to provide to the user device, in response to the request, a list of hyperlinks for information from third-parties that relates to the selected form location.

22. The apparatus claim 21 wherein at least one of the hyperlinks provides access to pages that are pre-populated with information relating to the selected form location.

23. The apparatus of claim 21 wherein at least one of the hyperlinks provides access to pages created based on a search of information contained in the individual ideas.

24. The apparatus of claim 21 wherein at least one of the hyperlinks provides access to information from subscription-based services.

25. The apparatus of claim 21 wherein the one or more servers are configured to:
authenticate the user to a third-party site associated with a selected hyperlink in a manner that is transparent to the user in response to receiving an indication of the user's selection of a hyperlink in the list; and
provide to the user information relating to the selected form location, wherein the provided information is obtained from the third-party site.

26. The apparatus of claim 17 wherein the one or more servers are configured to:
present on the display, via the computer network, an interactive depiction of a map, wherein the interactive depiction of the map allows for selection of a desired jurisdiction; and
deliver additional information through the network to the user device, wherein the additional information is delivered in response to a request for information relating to a geographic location on the map selected by the user by interacting with the depiction of the map, and wherein the additional information relates to the selected geographic location.

27. The apparatus of claim 26 wherein the form comprises a tax form, and wherein the information relating to the selected form location and the additional information relating to the selected geographic location comprise tax-related information.

28. The apparatus of claim 26 wherein the form relates to a specified subject, and wherein the information relating to the selected form location and the additional information relating to the selected geographic location comprise information about the specified subject.

29. The apparatus of claim 26 wherein the interactive map is presented in response to receiving a user selection from among a plurality of available interactive maps.

30. The apparatus of claim 26 wherein the form relates to a specified subject and wherein the interactive map comprises a plurality of geographic regions about which information relating to the specified subject may be obtained, and
wherein the one or more servers are configured to deliver to the user device information relating to the specified subject and associated with a particular geographic region selected by the user.

31. The apparatus of claim 26 wherein the form relates to a specified subject and wherein the interactive map depicts a plurality of countries about which information relating to the specified subject may be obtained, and
wherein the one or more servers are configured to deliver to the user device information relating to the specified subject and associated with a particular country selected by the user.

32. An article comprising a machine-readable medium storing machine-executable instructions that, when applied to a machine, cause the machine to:
present an interactive, graphical depiction of a form through a computer network and allow a user to select a desired location on the form; and
deliver information to the user through the network,
wherein the information is delivered in response to receiving a request for information relating to a location on the form selected by the user, the selection being made through interaction with the graphical depiction of the form, and
wherein the delivered information includes at least one of the following relating to the selected form location: planning information, consulting materials, research and compliance information.

33. The article of claim 32 wherein the form comprises a tax form.

34. The article of claim 32 wherein the selected form location corresponds to a section of the form identified by an alphanumeric designation.

35. The article of claim 32 including instructions that, when applied to the machine, cause the machine to:
retrieve, from a database, ideas that are linked to the selected form location; and
deliver the ideas to the user through the network.

36. The article of claim 35, including instructions that, when applied to the machine, cause the machine to:
provide to the user a list of hyperlinks for information from third-parties that relates to the selected form location.

37. The article of claim 36 wherein at least one of the hyperlinks provides access to pages that are pre-populated with information relating to the selected form location.

38. The article of claim 36 wherein at least one of the hyperlinks provides access to pages created based on a search of information contained in the individual ideas.

39. The article of claim 36 wherein at least one of the hyperlinks provides access to information from subscription-based services.

40. The article of claim 32 including instructions that, when applied to the machine, cause the machine to:
authenticate the user to a third-party site associated with the selected hyperlink in a manner that is transparent to the user in response to receiving an indication of the user's selection of a hyperlink in the list; and
provide to the user information relating to the selected form location, wherein the provided information is obtained from the third-party site.

41. The article of claim 32 including instructions that, when applied to the machine, cause the machine to:
present on the display, via the computer network, an interactive depiction of a map, wherein the interactive depiction of the map allows for selection of a desired jurisdiction; and
deliver additional information through the network to the user, wherein the additional information is delivered in response to a request for information relating to a geographic location on the map selected by the user, the selection being made by interacting with the depiction of the map, and wherein the additional information relates to the selected geographic location.

42. The article of claim 41 wherein the form comprises a tax form, and wherein the information relating to the selected form location and the additional information relating to the selected geographic location comprise tax-related information.

43. The article of claim 41 wherein the form relates to a specified subject, and wherein the information relating to the selected form location and the additional information relating to the selected geographic location comprise information about the specified subject.

44. The article of claim 41 wherein the interactive map is presented in response to receiving a user selection from among a plurality of available interactive maps.

45. The article of claim 41 wherein the form relates to a specified subject and wherein the interactive map comprises a plurality of geographic regions about which information relating to the specified subject may be obtained, and
wherein the article includes instructions, that when applied to the machine, cause the machine to:
deliver to the user, through the network, information relating to the specified subject and associated with a particular geographic region selected by the user.

46. The article of claim 41 wherein the form relates to a specified subject and wherein the interactive map depicts a plurality of countries about which information relating to the specified subject may be obtained, and
wherein the article includes instructions, that when applied to the machine, cause the machine to:
deliver to a user, through the network, information relating to the specified subject and associated with a particular country selected by the user.

47. A method comprising:
presenting an interactive depiction of a map through a network and allowing for selection of a desired jurisdiction;
receiving a request for information relating to a selected geographic location on the map in response to a user's interaction with the depiction of the map; and
delivering information to the user through the network wherein the information relates to the selected geographic location.

48. The method of claim 47 wherein the information relating to the selected geographic location comprises tax-related information.

49. The method of claim 47 wherein the information relating to the selected geographic location comprises information for use in connection with at least one of securities, banking and insurance industries.

50. The method of claim 47 wherein presenting the interactive map occurs in response to receiving a user's selection from among a plurality of available interactive maps.

51. The method of claim 47 including displaying one or more hyperlinks to subsets of the information in response to receiving the request for information.

52. The method of claim 47 wherein the interactive map depicts a plurality of states in the United States for which information relating to a specified subject may be obtained, wherein the method includes delivering to a user, through the network, information relating to the specified subject and associated with a particular state selected by the user via the interactive map.

53. The method of claim 47 wherein the interactive map depicts a plurality of countries for which information relating to a specified subject may be obtained, wherein the method includes delivering to a user, through the network, information relating to the specified subject and associated with a particular country selected by the user via the interactive map.

54. An apparatus comprising:
a computer network;
a user device coupled to the network, the user device including a display;
one or more servers coupled to the network to:
present on the display, via the computer network, an interactive depiction of a map, wherein the interactive depiction of the map allows for selection of a desired jurisdiction; and
deliver information through the network to the user device, wherein the information is delivered in response to a request for information relating to a geographic location on the map selected by the user by interacting with the depiction of the map, and wherein the additional information relates to the selected geographic location.

55. The apparatus of claim 54 wherein the information relating to the selected geographic location comprises tax-related information.

56. The apparatus of claim 54 wherein the information relating to the selected geographic location comprises information for use in connection with at least one of securities, banking and insurance industries.

57. The apparatus of claim 54 wherein the one or more servers are adapted to present the interactive map in response to receiving a user selection from among a plurality of available interactive maps.

58. The apparatus of claim 54 wherein the one or more servers are adapted to display one or more hyperlinks to subsets of the information in response to receiving the request for information.

59. The apparatus of claim 54 wherein the interactive map depicts a plurality of states in the United States for which information relating to a specified subject may be obtained, and wherein the one or more servers are adapted to deliver to the user device, through the network, information relating to the specified subject and associated with a particular state selected by the user via the interactive map.

60. The apparatus of claim 54 wherein the interactive map depicts a plurality of countries for which information relating to a specified subject may be obtained, and wherein the one or more servers are adapted to deliver to the user device, through the network, information relating to the specified subject and associated with a particular country selected by the user via the interactive map.

61. An article comprising a machine-readable medium storing machine-executable instructions that, when applied to a machine, cause the machine to:
present on a display an interactive depiction of a map, wherein the interactive depiction of the map allows for selection of a desired jurisdiction; and
deliver information through the network to a user, wherein the information is delivered in response to a request for information relating to a geographic location on the map selected by a user, the selection being made by interacting with the depiction of the map, and wherein the information relates to the selected geographic location.

62. The article of claims 61 wherein the information relating to the selected geographic location comprises tax-related information.

63. The article of claim 61 wherein the information relating to the selected geographic location comprises information for use in connection with at least one of securities, banking and insurance industries.

64. The article of claim 61 including instructions that, when applied to the machine, cause the machine to present the interactive map in response to receiving the user's selection from among a plurality of available interactive maps.

65. The article of claim 61 including instructions that, when applied to the machine, cause the machine to display one or more hyperlinks to subsets of the information in response to receiving the request for information.

66. The article of claim 61 wherein the interactive map depicts a plurality of states in the United States for which information relating to a specified subject may be obtained, and wherein the article includes instructions that, when applied to the machine, cause the machine to display information relating to the specified subject and associated with a particular state selected by the user via the interactive map.

67. The article of claim 61 wherein the interactive map depicts a plurality of countries for which information relating to a specified subject may be obtained, and wherein the article includes instructions that, when applied to the machine, cause the machine to display information relating to the specified subject and associated with a particular country selected by the user via the interactive map.
